(19) United States
(12) Patent Application Publication
(10) Pub. No.: US 2008/0299490 A1
(43) Pub. Date: Dec. 4, 2008

(54) WRITING METHOD AND CHARGED PARTICLE BEAM WRITING APPARATUS

(75) Inventor: Hidekazu TAKEKOSHI, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: NuFlare Technology, Inc., Numazu-shi (JP)

(21) Appl. No.: 12/124,724

(22) Filed: May 21, 2008

(30) Foreign Application Priority Data
May 28, 2007 (JP) 2007-140404

(51) Int. Cl. G03C 5/00; G21K 5/04

(52) U.S. Cl. 430/296; 250/492.2

(57) ABSTRACT

A charged particle beam writing apparatus includes a stage on which a first mask substrate and a second mask substrate are arranged side by side, and a writing unit to write a first pattern on the first mask substrate and a second pattern, which complements the first pattern, on the second mask substrate, by using charged particle beams.

### CROSS-REFERENCE TO RELATED APPLICATION

This application is based upon and claims the benefit of priority from the prior Japanese Patent Application No. 2007-140404 filed on May 28, 2007 in Japan, the entire contents of which are incorporated herein by reference.

### BACKGROUND OF THE INVENTION

1. Field of the Invention

The present invention relates to a writing method and a charged particle beam writing apparatus, and more particularly to an apparatus and a method for writing complementary patterns used for double patterning or double exposure.

2. Description of Related Arts

A lithography technique that advances microminiaturization of semiconductor devices is an extremely important process which is only a process for forming patterns in semiconductor manufacturing processes. In recent years, with high integration of large-scale integrated circuits (LSI), a circuit critical dimension required for semiconductor devices is becoming smaller year by year. In order to form a desired circuit pattern on the semiconductor devices, there is required a master pattern (also called a mask or a reticle) with high precision.

Then, with the miniaturization of the circuit critical dimension, an exposure light source having a shorter wavelength is becoming required. As a life extension method of an ArF laser being an example of the exposure light source, a double exposure technique and a double patterning technique attract attention in recent years. The double exposure is a method of continuously exposing the same region on a wafer coated with resist, while performing an exchange between two masks. Then, after the exposing, through developing and etching processes, a desired pattern is formed on the wafer. On the other hand, the double patterning is a method of exposing a wafer coated with resist by using a first mask, and after developing, etching, and coating the wafer with resist again, exposing the same region on the wafer by using a second mask. These techniques have an advantage in that they can be performed as an extension of the current technique. In these techniques, two masks are needed in order to obtain a desired pattern on the wafer.

FIG. 9 shows a schematic diagram for describing a conventional double patterning mask. As shown in FIG. 9, since sufficient resolution cannot be obtained by using the photomask 300, the mask needs to be divided into two masks so that a desired pattern 302 may be exposed onto the wafer. That is, a pattern 312 being a part of the pattern 302 is formed on a photomask 310, and a pattern 314 being a residual part of the pattern 302 is formed on a photomask 320. Then, these two photomasks 310 and 320 are set in order in the exposure apparatus, such as a stepper and a scanner, to be exposed respectively.

These photomasks are manufactured by using an electron beam writing apparatus. The electron beam writing technology intrinsically has excellent resolution and is used for production of highly precise master patterns.

FIG. 10 shows a schematic diagram illustrating operations of a variable-shaped type electron beam writing apparatus. As shown in the figure, the variable-shaped electron beam (EB) writing apparatus includes two aperture plates and operates as follows: A first or “upper” aperture plate 410 has a rectangular opening or “hole” 411 for shaping an electron beam 330. This shape of the rectangular opening may also be a square, a rhombus, a rhomboid, etc. A second or “lower” aperture plate 420 has a variable-shaped opening 421 for shaping the electron beam 330 that passed through the opening 411 into a desired rectangular shape. The electron beam 330 being emitted from a charged particle source 430 and having passed through the opening 411 is deflected by a deflector to penetrate a part of the variable-shaped opening 421 of the second aperture plate 420 and thereby to irradiate a target workpiece or “sample” 340 mounted on a stage which is continuously moving in one predetermined direction (e.g. x direction) during the writing or “drawing”. In other words, a rectangular shape capable of passing through both the opening 411 and the variable-shaped opening 421 is written in the writing region of the target workpiece 340 mounted on the stage continuously moving. This method of writing or “forming” a given shape by letting beams pass through both the opening 411 and the variable-shaped opening 421 is referred to as a “variable shaping” method.

By the operations of the electron beam writing apparatus mentioned above, a plurality of photomasks for the double exposure and a plurality of photomasks for the double patterning exposure are manufactured. Then, when writing by using the electron beam pattern writing apparatus, drift of the electron beam occurs as a temporal change. As a result, there is a problem that placement error occurs between mask patterns which have a complementary relation with each other.

Moreover, as mentioned above, it is necessary to perform an exchange between two masks in the double exposure or the double patterning exposure. Therefore, position alignment when setting the mask in the exposure apparatus is important. If the positions deviate from each other, consequently a overlay error of the patterns is produced. Then, a problem arises in that such an error directly affects the critical dimension of the pattern.

Then, there is disclosed a technique that forms patterns in the x and y directions on one mask for multi-exposure, wherein the patterns are not superimposed unlike the techniques of the double exposure and the double patterning (refer to, e.g., Japanese Unexamined Patent Publication No. 2007-72423 (JP-A-2007-72423)).

In the mask manufacture process, as mentioned above, there has been a problem of an error being produced between the writing positions of complementary mask patterns caused by drift of the electron beam. Therefore, an overlay error occurs when exposing using such a mask, thereby resulting in a problem of a CD error. Moreover, an overlay error also occurs by a position alignment error when performing an exchange between two masks, thereby also resulting in the problem of a CD error.

### BRIEF SUMMARY OF THE INVENTION

An object of the present invention is to provide a writing method and a writing apparatus capable of reducing overlay errors.

In accordance with one aspect of the present invention, a writing method includes virtually dividing a virtual region including a first writing region and a second writing region, which are adjacent to each other, into a plurality of small strip-like regions so that each corresponding position of the first writing region and the second writing region may be included in the same small region of the plurality of small strip-like regions; and writing, with respect to each of the plurality of small strip-like regions, a first pattern in the first writing region and a second pattern, which complements the first pattern, in the second writing region.

In accordance with another aspect of the present invention, a writing method includes virtually dividing a first writing region and a second writing region, which are adjacent to each other, into a plurality of small regions respectively; and writing a first pattern in the first writing region and a second pattern, which complements the first pattern, in the second writing region so that corresponding two small regions of the plurality of small regions in the first writing region and the second writing region may be continuously written.

In accordance with another aspect of the present invention, a charged particle beam writing apparatus includes a stage on which a first mask substrate and a second mask substrate are arranged side by side, and a writing unit configured to write a first pattern on the first mask substrate and a second pattern, which complements the first pattern, on the second mask substrate, by using charged particle beams.

In accordance with another aspect of the present invention, a charged particle beam writing apparatus includes a stage on which a mask substrate is arranged, and a writing unit configured to write a first pattern in a first writing region of the mask substrate, and a second pattern, which complements the first pattern, in a second writing region adjacent to the first writing region of the mask substrate, by using charged particle beams.

### BRIEF DESCRIPTION OF THE DRAWINGS

FIG. 1 is a schematic diagram showing a structure of a pattern writing apparatus described in Embodiment 1;

FIG. 2 shows a schematic diagram for explaining an example of a double exposure (DE) photomask described in Embodiment 1;

FIG. 3 is a flowchart showing main steps of a writing method of the double exposure (DE) photomask described in Embodiment 1;

FIG. 4 shows a schematic diagram illustrating a state viewed from the upper side of mask substrates arranged on the stage described in Embodiment 1;

FIG. 5 shows a schematic diagram illustrating a state viewed from the upper side of a mask substrate arranged on the stage described in Embodiment 2;

FIG. 6 shows a schematic diagram illustrating a state viewed from the upper side of mask substrates arranged on the stage described in Embodiment 3;

FIG. 7 shows a schematic diagram illustrating a state viewed from the upper side of a mask substrate arranged on the stage described in Embodiment 4;

FIG. 8A shows a schematic diagram for explaining a method of writing after rotating a mask substrate for changing the direction;

FIG. 8B shows a schematic diagram for explaining a method of writing after rotating a mask substrate for changing the direction;

FIG. 9 shows a schematic diagram for describing a conventional double patterning mask; and

FIG. 10 shows a schematic diagram illustrating operations of a conventional variable-shaped type electron beam writing apparatus.

### DETAILED DESCRIPTION OF THE INVENTION

In the following Embodiments, a structure utilizing an electron beam as an example of a charged particle beam will be described. The charged particle beam is not limited to the electron beam, but may be a beam using other charged particle, such as an ion beam.

### Embodiment 1

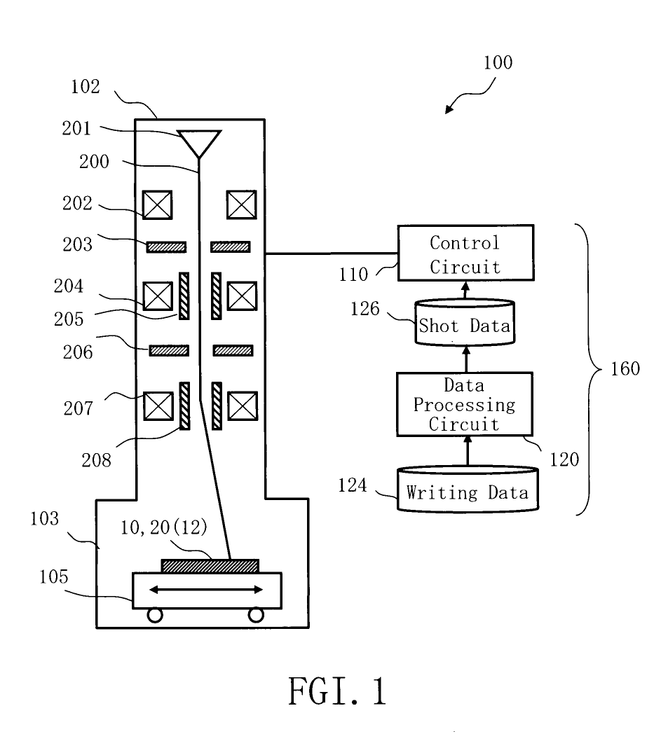

FIG. 1 is a schematic diagram showing a structure of a pattern writing apparatus described in Embodiment 1. In FIG. 1, a pattern writing apparatus 100 includes an electron lens barrel 102, a writing chamber 103, and a control unit 160. The pattern writing apparatus 100 serves as an example of a charged particle beam writing apparatus. The pattern writing apparatus 100 writes a plurality of desired complementary patterns on two mask substrates 10 and 20 or one mask substrate 12. The control unit 160 includes a control circuit 110, a data processing circuit 120, and magnetic disk drives 124 and 126. The electron lens barrel 102 serves as an example of a writing unit. In the electron lens barrel 102, there are arranged an electron gun assembly 201, an illumination lens 202, a first aperture plate 203, a projection lens 204, a deflector 205, a second aperture plate 206, an objective lens 207, and a deflector 208. In the writing chamber 103, there is an XY stage 105 which is movably arranged. On the XY stage 105, there are placed the two mask substrates 10 and 20 or one mask substrate 12. Each of the two mask substrates 10 and 20 or one mask substrate 12 is a photomask substrate for the double exposure or the double patterning exposure. These mask substrates include, for example, a mask blank where no pattern is formed. FIG. 1 shows structure parts necessary for describing Embodiment 1. It should be understood that other structure elements generally necessary for the pattern writing apparatus 100 may also be included.

In the magnetic disk drive 124, writing data is stored. The data processing circuit 120 reads the writing data from the magnetic disk drive 124, and converts it to shot data of a format used in the apparatus. The shot data is stored in the magnetic disk drive 126. Based on this shot data, the control circuit 110 controls each device in the electron lens barrel 102 and the writing chamber 103. Operations in the electron lens barrel 102 and the writing chamber 103 will now be explained.

An electron beam 200 emitted from the electron gun assembly 201 irradiates the whole of the first aperture plate 203 having a rectangular opening or “hole” by using the illumination lens 202. This shape of the rectangular opening may also be a square, rhombus, a rhomboid, etc. The electron beam 200 is shaped to be a rectangle. Then, after having passed through the first aperture plate 203, the electron beam 200 of a first aperture image is projected onto the second aperture plate 206 by the projection lens 204. The position of the first aperture image on the second aperture plate 206 is controlled by the deflector 205, and thereby the shape and size of the beam can be changed. That is, the electron beam 200 is formed. After having passed through the second aperture plate 206, the electron beam 200 of a second aperture image is focused by the objective lens 207 and deflected by the deflector 208, to reach a desired position on the two mask substrates 10 and 20 or one mask substrate 12 placed on the XY stage 105. The XY stage 105 performs the operation of continuous movement or step and repeat movement. That is, the pattern writing apparatus 100 performs writing while the XY stage 105 is moving continuously. Alternatively, the pattern writing apparatus 100 performs writing while the XY stage 105 is stopping during the step and repeat movement.

At this point, a complementary pattern is exposed (transferred) onto a substrate, such as a wafer, by the exposure apparatus in which a photomask for double exposure or double patterning exposure is used. As the exposure apparatus, a scanner apparatus or a stepper apparatus may be used. As an exposure region of the exposure apparatus, for example, an area equal to or greater than 20×30 mm is prescribed in the scanner apparatus. However, in an actual device, it is rare that one chip occupies the whole of the exposure area. Therefore, a plurality of the same chips are to be formed in one mask.

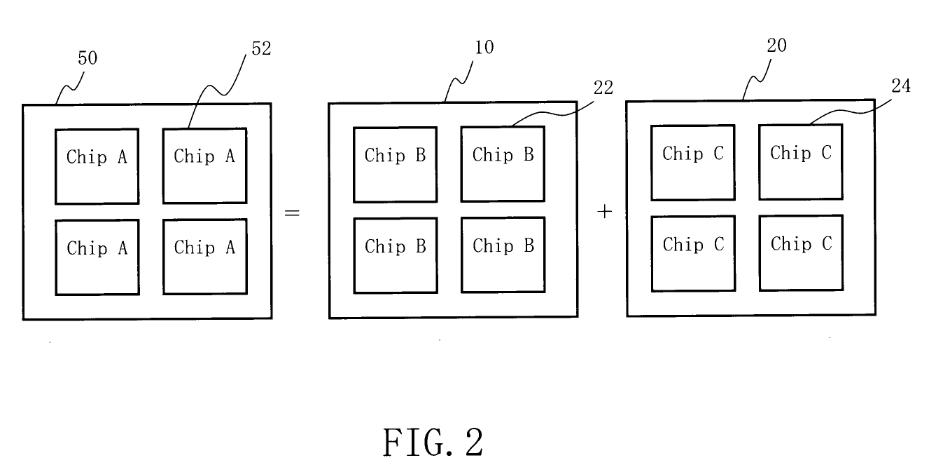

FIG. 2 shows a schematic diagram for explaining an example of the double exposure (DE) photomask described in Embodiment 1. Supposing that a plurality of the same chips are formed, for example, four desired patterns 52 of chips A are formed on a photomask substrate 50 as shown in FIG. 2. However, when using a beam, such as an ArF laser used in the exposure apparatus, if the beam is intact, the resolution exceeds the limit. Therefore, the photomask substrate 50 is divided into the mask substrate 10 being a mask B and the mask substrate 20 being a mask C. Four desired patterns 22 of chips B are formed on the mask substrate 10, and four desired patterns 24 of chips C, each of which complements the four patterns 22 respectively, are formed on the mask substrate 20. Thus, it is possible to increase the productivity, by having a plurality of chips on one mask. The same can be applied to the double exposure photomask.

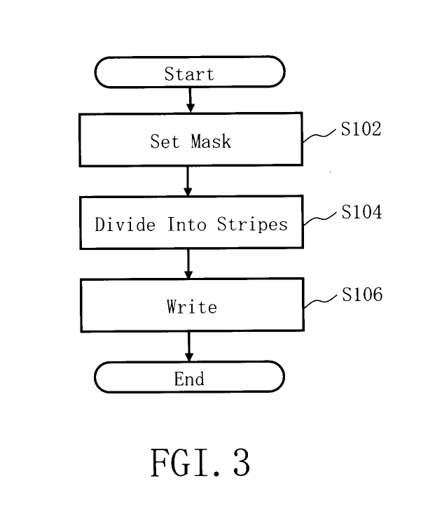

FIG. 3 is a flowchart showing main steps of a writing method of the double exposure (DE) photomask described in Embodiment 1. In S (step) 102, as a mask setting step, two or more mask substrates 10 and 20 to be written are arranged on the XY stage 105.

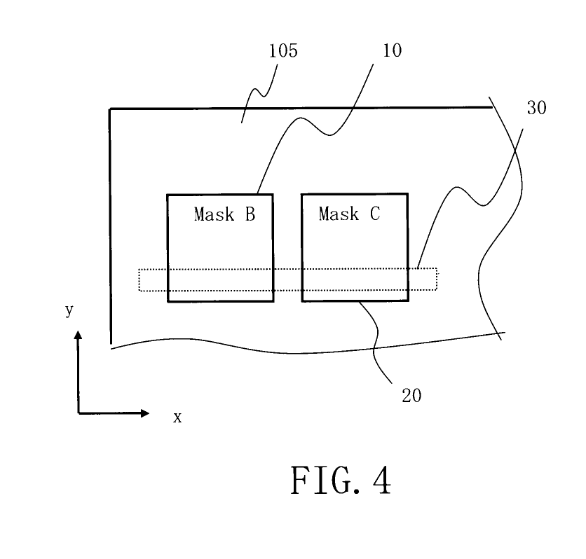

FIG. 4 shows a schematic diagram illustrating a state viewed from the upper side of the mask substrates arranged on the stage described in Embodiment 1. FIG. 4 shows the state where the two mask substrates 10 and 20 are arranged on the XY stage 105. When the writing direction of the pattern writing apparatus 100 is in the x direction, it is preferable to arrange the mask substrates to be side by side in the x direction while aligning the y-coordinates of the complementary parts of each pattern.

In the step S104, as a stripe dividing step, the data processing circuit 120 virtually divides the virtual region including the writing region (first writing region) on the mask substrate 10 and the writing region (second writing regions) on the mask substrate 20 into a plurality of strip-like stripes 30 so that each corresponding position of the adjacent mask substrates 10 and 20 may be included in the same stripe 30 (small region). FIG. 4 shows one stripe 30 of them. The width of the stripe 30 is deflectable by the deflector 208.

In the step S106, as a writing step, each device in the electron lens barrel 102 writes a pattern in each stripe 30 by using the electron beam 200: the pattern 22 is written on the mask substrate 10 and the pattern 24, which complements the pattern 22, is written on the mask substrate 20. The pattern writing is performed by deflecting the electron beam 200 to a desired position in the stripe 30 by the deflector 208 while the XY stage 105 continuously moves in the −x direction. By continuously moving the XY stage 105 in the −x direction, writing is relatively performed in the x direction. Therefore, after the pattern in the stripe 30 of the mask substrate 10 is written, continuously the pattern in the stripe 30 of the mask substrate 20 is written. Thus, the time interval between writing the corresponding positions of the mask substrates 10 and 20 becomes short. That is, compared with the case in which the mask substrate 20 is written after all of the mask substrate 10 having been written, the writing time of the complementary patterns become close each other. Therefore, both the mask substrates can be written in the state in which temporal change caused by drift of the beam is little. Consequently, two complementary photomasks with high positional accuracy can be manufactured. As a result, it is possible to reduce overlay errors in the wafer or the like which is exposed by using the two complementary photomasks. In other words, by arranging the mask substrates 10 and 20 side by side on the XY stage 105, it becomes possible to apply the writing method described above.

As mentioned above, according to Embodiment 1, the virtual region including the first and the second writing regions is virtually divided into a plurality of small strip-like regions so that each corresponding position of the adjacent first and second writing regions may be included in the same small region. As a result, both of the corresponding positions of the adjacent first and second writing regions are in the same small region. Then, with respect to each small region, the first pattern is written in the first writing region and the second pattern which complements the first pattern is written in the second writing region. Thereby, since the writing is performed for each small region, the time interval between writing the corresponding positions of the first and second writing regions becomes short. That is, compared with the case in which the second writing region is written after all of the first writing region having been written, the writing time of the complementary patterns become close each other. Therefore, both the writing regions can be written in the state in which temporal change caused by drift of the beam is little. Consequently, it is possible to reduce overlay errors.

### Embodiment 2

In Embodiment 1, the structure in which the two mask substrates 10 and 20 are arranged side by side on the XY stage 105 is described with reference to FIG. 4. In Embodiment 2, a photomask writing method capable of further reducing overlay errors will be described. In the case of writing the complementary patterns by dividing them into the two mask substrates 10 and 20 as mentioned above, it is necessary to perform an exchange of the masks in the exposure apparatus. Therefore, even if the writing positional accuracy is enhanced, it is still difficult to avoid displacement at the time of exchanging both the masks. Consequently, a overlay error still remains. Then, according to the present Embodiment, the double exposure (DE) photomask is manufactured as follows. The apparatus structure to be used is the same as that shown in FIG. 1, and each main step of the writing method is the same as that shown in FIG. 3.

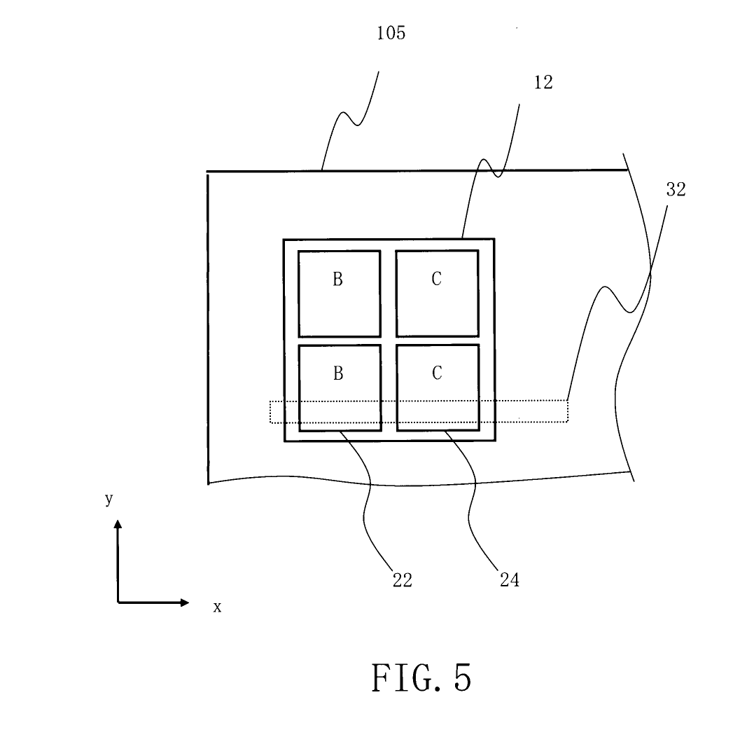

In the step S102, as a mask setting step, one mask substrate 12 to be written is placed on the XY stage 105. FIG. 5 shows a schematic diagram illustrating a state viewed from the upper side of the mask substrate arranged on the stage described in Embodiment 2. As shown in FIG. 5, both the complementary pattern 22 of chips B and pattern 24 of chips C are formed on one mask substrate 12. The pattern 22 is formed in a writing region (first writing region) on the mask substrate 12. The pattern 24 is formed in another writing region (second writing region) on the mask substrate 12. By virtue of forming both of the two patterns 22 and 24 which complement each other on one mask substrate 12, it becomes possible to avoid the displacement occurred at the time of exchanging the masks in the exposure apparatus. In the case of the writing direction of the pattern writing apparatus 100 is in the x direction, it is preferable to arrange the two patterns 22 and 24 side by side in the x direction while aligning the y-coordinates of the complementary parts of each pattern.

As mentioned above, it is rare that one chip occupies the whole of the exposure area. Then, according to the present Embodiment as shown in FIG. 5, it is possible to arrange a plurality of chips for example, in addition to capable of arranging the complementary two mask patterns 22 and 24 side by side. FIG. 5 shows an example where two each of the mask patterns 22 and 24 are arranged. Thus, by virtue of having a plurality of chips on one mask, the productivity can be further increased while avoiding the conventional displacement.

In the step S104, as a stripe dividing step, the data processing circuit 120 virtually divides the region including the regions used for writing the patterns 22 and 24 into a plurality of strip-like stripes 32 so that each corresponding position of the adjacent patterns 22 and 24 of chips B and C may be included in the same stripe 32 (small region). FIG. 5 shows one stripe 32 of them. The width of the stripe 32 is deflectable by the deflector 208.

In the step S106, as a writing step, each device in the electron lens barrel 102 writes a pattern in each stripe 32 by using the electron beam 200: the pattern 22 is written in the writing region (first writing region) of chip B, and the pattern 24, which complements the pattern 22, is written in the writing region (second writing region) of chip C on the mask substrate 12. The pattern writing is performed by deflecting the electron beam 200 to a desired position in the stripe 32 by the deflector 208 while the XY stage 105 continuously moves in the −x direction. By continuously moving the XY stage 105 in −x direction, writing is relatively performed in x direction. Therefore, after the pattern in the stripe 32 in the writing region of chip B is written, continuously the pattern in the stripe 32 in the writing region of chip C is written. Thus, the time interval between writing the corresponding positions of the chips B and C becomes short. That is, compared with the case in which the writing region of chip C is written after all of the writing region of chip B having been written, the writing time of the complementary patterns become close each other. Therefore, both the patterns of the chips B and C can be written in the state in which temporal change caused by drift of the beam is little. Consequently, two complementary chip patterns of chips B and C with high positional accuracy can be manufactured. As a result, it is possible to reduce overlay errors in the wafer or the like which is exposed by using one photomask in which the two complementary patterns of chips B and C are formed.

As mentioned above, in Embodiment 2 similar to Embodiment 1, the virtual region including the first and the second writing regions is virtually divided into a plurality of small strip-like regions so that each corresponding position of the adjacent first and second writing regions may be included in the same small region. As a result, both of the corresponding positions of the adjacent first and second writing regions are in the same small region. Then, with respect to each small region, the first pattern is written in the first writing region and the second pattern which complements the first pattern is written in the second writing region. Thereby, since the writing is performed for each small region, the time interval between writing the corresponding positions of the first and second writing regions becomes short. That is, compared with the case in which the second writing region is written after all of the first writing region having been written, the writing time of the complementary patterns become close each other. Therefore, both the writing regions can be written in the state in which temporal change caused by drift of the beam is little. Consequently, it is possible to reduce overlay errors.

### Embodiment 3

In Embodiment 1, the case of continuous writing by moving the XY stage continuously has been explained with reference to FIG. 4. In Embodiment 3, there will be described a method of writing a double exposure (DE) photomask by moving the XY stage by the step and repeat operation. The apparatus structure is the same as that of FIG. 1. Each main step in the writing method is the same as that of FIG. 3 other than reading the stripe as a field.

In the step S102, as a mask setting step, two or more mask substrates 10 and 20 to be written are arranged on the XY stage 105.

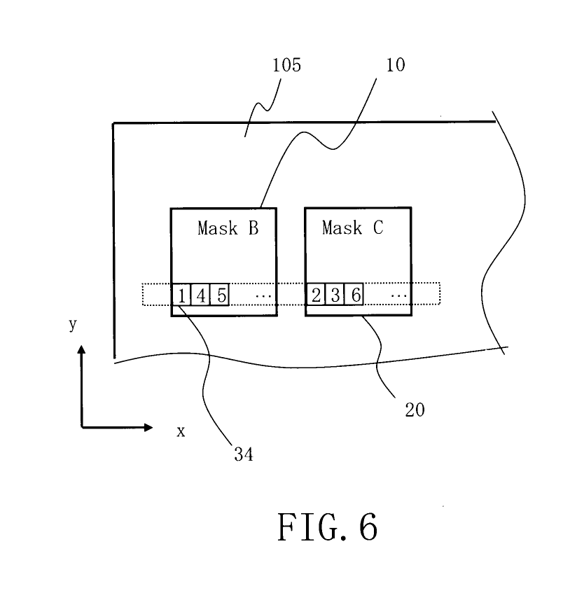

FIG. 6 shows a schematic diagram illustrating a state viewed from the upper side of the mask substrates arranged on the stage described in Embodiment 3. FIG. 6 shows the state, like Embodiment 1, where the two mask substrates 10 and 20 are arranged on the XY stage 105. When the writing direction of the pattern writing apparatus 100 is in the x direction, it is preferable to arrange the mask substrates to be side by side in the x direction while aligning the y-coordinates of the complementary parts of each pattern.

In the step S104, as a field dividing step, the data processing circuit 120 virtually divides the writing regions of the adjacent mask substrates 10 and 20 into a plurality of fields 34 (small regions) respectively, each of which is a square or a rectangle whose width and length is deflectable by the deflector 208. FIG. 6 shows a series of fields 34 of the plurality of fields 34, which do not need to be moved by the XY stage 105 in the y direction and each of which is placed side by side in the x direction.

In the step S106, as a writing step, each device in the electron lens barrel 102 writes a pattern by using the electron beam 200: the pattern 22 is written on the mask substrate 10 and the pattern 24, which complements the pattern 22, is written on the mask substrate 20 so that the corresponding two fields 34 in the writing regions of the mask substrates 10 and 20 may be continuously written. The pattern is written by deflecting the electron beam 200 by the deflector 208 onto a desired position in the field 34 at the position where the movement of the XY stage 105 is stopped during its step movement in ± direction. First, the field 34 denoted by 1 in the mask substrate 10 is written. Next, the complementary field 34 denoted by 2 in the mask substrate 20 is written. Then, without returning to the mask substrate 10, the field 34 denoted by 3, which is next to 2, in the mask substrate 20 is written. Next, returning to the mask substrate 10, the complementary field 34 denoted by 4 in the mask substrate 10 is written. Then, the complementary field 34 denoted by 5, which is next to 4, in the mask substrate 10 is written. Next, the complementary field 34 denoted by 6 in the mask substrate 20 is written. Thus, the step position is set so that the corresponding two fields 34, which are in a complementary relation, may be continuously written. That is, compared with the case in which the field in the mask substrate 20 is written after all of the fields in the mask substrate 10 having been written, the writing time of the corresponding two fields become close each other. Therefore, both the fields can be written in the state in which temporal change caused by drift of the beam is little. Consequently, two complementary photomasks with high positional accuracy can be manufactured. As a result, it is possible to reduce overlay errors in the wafer or the like which is exposed by using the two complementary photomasks. In other words, by arranging the mask substrates 10 and 20 side by side on the XY stage 105, it becomes possible to apply the writing method described above.

As mentioned above, according to Embodiment 3, each of the adjacent first and second writing regions is virtually divided into a plurality of small regions. The first pattern is written in the first writing region and the second pattern which complements the first pattern is written in the second writing region so that the corresponding two small regions in the first and second writing regions may be continuously written. By virtue of this, the corresponding two small regions in the first and second writing regions are written continuously. That is, compared with the case in which the second region is written after all of the first writing region having been written, the writing time of the corresponding two small regions become close each other. Therefore, both the writing regions can be written in the state in which temporal change caused by drift of the beam is little. Consequently, it is possible to reduce overlay errors.

### Embodiment 4

In Embodiment 2, the case of continuous writing by moving the XY stage continuously has been explained with reference to FIG. 5. In Embodiment 4, there will be described a method of writing a double exposure (DE) photomask by moving the XY stage by the step and repeat operation like Embodiment 3. The apparatus structure is the same as that of FIG. 1. Each main step in the writing method is the same as that of FIG. 3 other than reading the stripe as a field.

In the step S102, as a mask setting step, one mask substrate 12 to be written is placed on the XY stage 105.

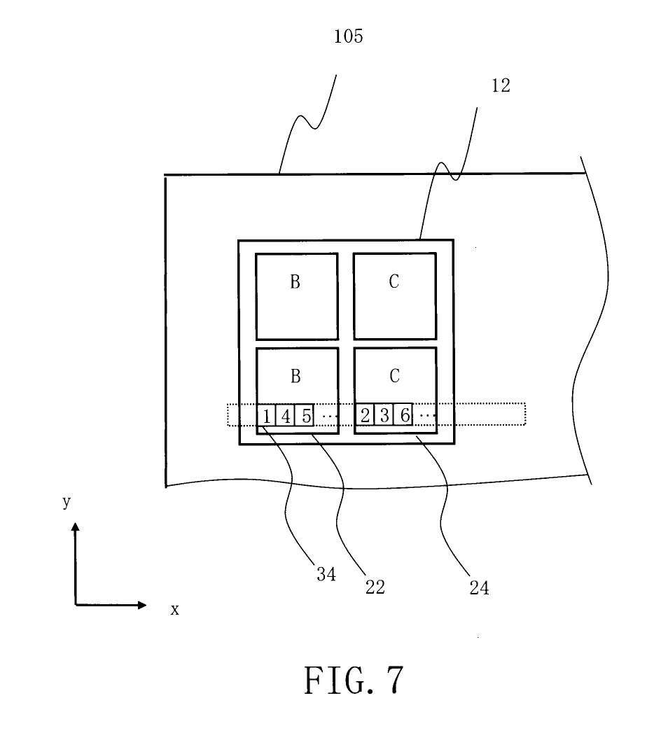

FIG. 7 shows a schematic diagram illustrating a state viewed from the upper side of the mask substrate placed on the stage described in Embodiment 4. FIG. 7 shows the state, like Embodiment 2, where one mask substrate 12 is placed on the XY stage 105. On this one mask substrate 12, both the pattern 22 of chip B and the pattern 24 of chip C are formed. By virtue of forming both of the two patterns 22 and 24 which complement each other on the one mask substrate 12, it becomes possible to avoid the displacement occurred at the time of exchanging the masks in the exposure apparatus. Similarly to Embodiment 2, in the case of the writing direction of the pattern writing apparatus 100 is in the x direction, it is preferable to arrange the two patterns 22 and 24 side by side in the x direction while aligning the y-coordinates of the complementary parts of each pattern.

In the step S104, as a field dividing step, the data processing circuit 120 virtually divides the writing regions of the adjacent chips B and C into a plurality of fields 34 (small region) respectively, each of which is a square or a rectangle whose width and length is deflectable by the deflector 208. FIG. 7 shows a series of fields 34 of the plurality of fields 34, which do not need to be moved by the XY stage 105 in the y direction and each of which is placed side by side in the x direction.

In the step S106, as a writing step, each device in the electron lens barrel 102 writes a pattern by using the electron beam 200: the pattern 22 is written in the writing region of chip B, and the pattern 24, which complements the pattern 22, is written in the writing region of chip C on the mask substrate 12 so that the corresponding two fields 34 in the writing regions of the chips B and C may be continuously written. The pattern is written by deflecting the electron beam 200 by the deflector 208 onto a desired position in the field 34 at the position where the movement of the XY stage 105 is stopped during its step movement in ± direction. First, the field 34 denoted by 1 in the writing region of chip B is written. Next, the complementary field 34 denoted by 2 in the writing region of chip C is written. Then, without returning to the writing region of chip B, the field 34 denoted by 3, which is next to 2, in the writing region of chip C is written. Next, returning to the writing region of chip B, the complementary field 34 denoted by 4 in the writing region of chip B is written. Then, the complementary field 34 denoted by 5 in the writing region of chip B, which is next to 4, is written. Next, the complementary field 34 denoted by 6 in the writing region of chip C is written. Thus, the step position is set so that the corresponding two fields 34, which are in a complementary relation, may be continuously written. That is, compared with the case in which the writing region of chip C is written after all of the fields in the writing region of chip B having been written, the writing time of the corresponding two fields become close each other. Therefore, both the patterns of the chips can be written in the state in which temporal change caused by drift of the beam is little. Consequently, two complementary photomasks with high positional accuracy can be manufactured. As a result, it is possible to reduce overlay errors in the wafer or the like which is exposed by using the two complementary photomasks.

As mentioned above, in Embodiment 4 similar to Embodiment 3, each of the adjacent first and second regions is virtually divided into a plurality of small regions. The first pattern is written in the first writing region and the second pattern which complements the first pattern is written in the second writing region so that the corresponding two small regions in the first and second writing regions may be continuously written. By virtue of this, the corresponding two small regions in the first and second writing regions are written continuously. That is, compared with the case in which the second writing region is written after all of the first writing region having been written, the writing time of the corresponding two small regions become close each other. Therefore, both the writing regions can be written in the state in which temporal change caused by drift of the beam is little. Consequently, it is possible to reduce overlay errors.

As to Embodiments 2 and 4, when the scanner apparatus scans in the y direction while the pattern writing apparatus 100 writes in the x direction, it is preferable to write as follows:

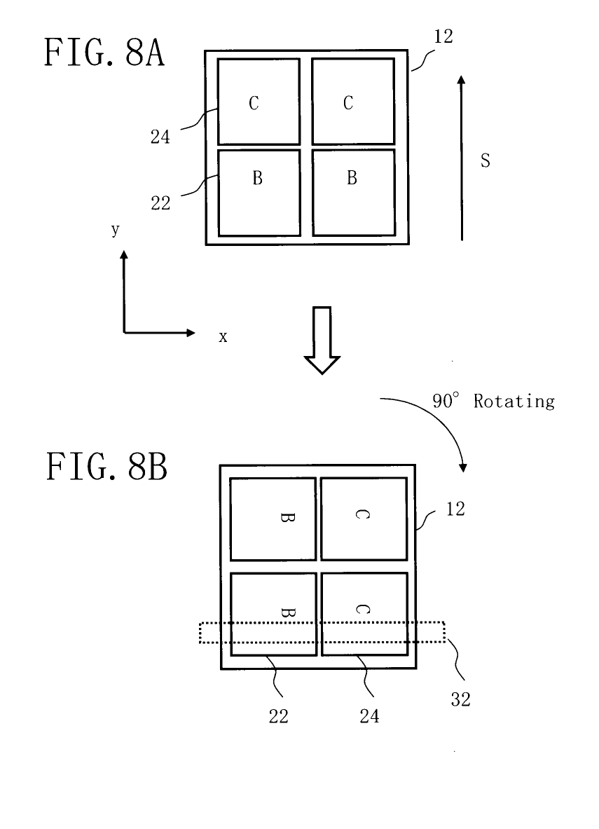

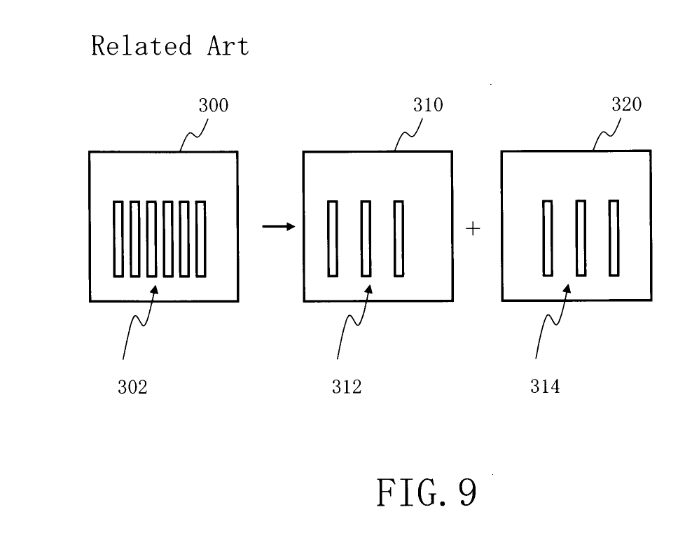

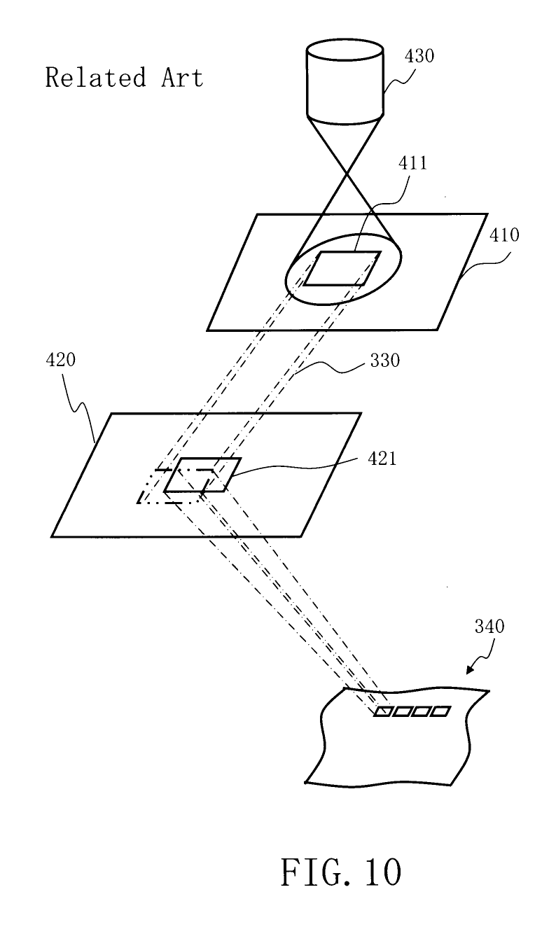

FIGS. 8A and 8B are schematic diagrams for explaining a method of writing after rotating the mask substrate to change the direction. When exposing (transferring) by using a scanner apparatus, it is preferable the two patterns 22 and 24 which complement each other are formed in a line along the scanning direction S of the scanner apparatus. For example, as shown in FIG. 8A, when scanning in the y direction, the patterns 22 and 24 are arranged in a line in the y direction to be formed. The position in the x direction, being orthogonal to the scanning direction, needs to be aligned. By virtue of arranging in this way, movement in the x direction during the scanning can be avoided. However, if writing is performed in such a positional relation, it is impossible to divide the patterns 22 and 24 into one stripe or a series of fields, in the pattern writing apparatus 100. Then, as shown in FIG. 8B, by rotating the mask substrate 12 by 90 degrees, the regions of the chips B and C, on which the complementary two patterns 22 and 24 are to be written, can be arranged in the x direction being the writing direction. As the direction of the rotating, either +90 or −90 degrees can be used.

While the embodiments have been described above with reference to specific examples, the present invention is not restricted to these specific examples. Each method mentioned above can be similarly applied to a double exposure photomask which exposes a plurality of superimposed complementary patterns.

Although description of the apparatus structure, control method, etc. not directly required for explaining the present invention is omitted, it is acceptable to suitably select and use some or all of them when needed.

In addition, any other writing method and charged particle beam writing apparatus that include elements of the present invention and that can be appropriately modified by those skilled in the art are included within the scope of the present invention.

Additional advantages and modification will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A writing method comprising:
virtually dividing a virtual region including a first writing region and a second writing region, which are adjacent to each other, into a plurality of small strip-like regions so that each corresponding position of the first writing region and the second writing region may be included in a same small region of the plurality of small strip-like regions; and
writing, with respect to each of the plurality of small strip-like regions, a first pattern in the first writing region and a second pattern, which complements the first pattern, in the second writing region.

2. The method according to claim 1, wherein the first writing region is on a first mask substrate and the second writing region is on a second mask substrate.

3. The method according to claim 1, wherein the first writing region and the second writing region are on one mask substrate.

4. A writing method comprising:
virtually dividing a first writing region and a second writing region, which are adjacent to each other, into a plurality of small regions respectively; and
writing a first pattern in the first writing region and a second pattern, which complements the first pattern, in the second writing region so that corresponding two small regions of the plurality of small regions in the first writing region and the second writing region may be continuously written.

5. The method according to claim 4, wherein the first writing region is on a first mask substrate and the second writing region is on a second mask substrate.

6. The method according to claim 4, wherein the first writing region and the second writing region are on one mask substrate.

7. A charged particle beam writing apparatus comprising:
a stage on which a first mask substrate and a second mask substrate are arranged side by side; and
a writing unit configured to write a first pattern on the first mask substrate and a second pattern, which complements the first pattern, on the second mask substrate, by using charged particle beams.

8. The apparatus according to claim 7, wherein
a virtual region including the first mask substrate and the second mask substrate is virtually divided into a plurality of small strip-like regions so that each corresponding position of the first mask substrate and the second mask substrate may be included in a same small region of the plurality of small strip-like regions, and
the writing unit writes, with respect to each of the plurality of small strip-like regions, the first pattern on the first mask substrate and the second pattern on the second mask substrate.

9. The apparatus according to claim 7, wherein
each writing region in the first mask substrate and the second mask substrate is virtually divided into a plurality of small regions respectively, and
the writing unit writes the first pattern on the first mask substrate and the second pattern on the second mask substrate so that corresponding two small regions of the plurality of small regions in the first mask substrate and the second mask substrate may be continuously written.

10. A charged particle beam writing apparatus comprising:
a stage on which a mask substrate is arranged; and
a writing unit configured to write a first pattern in a first writing region of the mask substrate, and a second pattern, which complements the first pattern, in a second writing region adjacent to the first writing region of the mask substrate, by using charged particle beams.
